(19) United States
(12) Patent Application Publication
(10) Pub. No.: US 2006/0191365 A1
(43) Pub. Date: Aug. 31, 2006

(54) Gearset, in particular for electric hand machine tools

(76) Inventors: Peter Stierle, Liebenaustrasse (DE); Juergen Wiker, Klein Obergasse (DE); Joachim Schadow, Echersingerstrasse (DE)

Correspondence Address: Striker Striker & Stenby, 103 East Neck Road, Huntington, NY, 11743, US

(21) Appl. No.: 10/528,987

(22) PCT Filed: Jul. 21, 2003
(86) PCT No.: PCT/DE03/02427

§ 371 Date: Mar. 24, 2005

(30) Foreign Application Priority Data
Dec. 19, 2002 (DE) 102 59 519.4

(51) Int. Cl. F16H 55/14

(52) U.S. Cl. 74/411

(57) ABSTRACT

A gear mechanism, in particular for hand power tools, is disclosed which has a driving gear wheel (12), seated on a drive shaft (11) in the manner fixed against relative rotation, and a driven gear wheel (13), meshing with the driving gear wheel and driving a driven shaft (14). To attain high running smoothness of the gear mechanism and a longer service life by reducing the mechanical load on the gearing upon startup and in load peaks that occur during operation, spring-elastic damping elements (22) are located between the driven gear wheel (13) and the driven shaft (14) (FIG. 2).

### PRIOR ART

The invention is based on a gear mechanism, in particular for hand power tools, as generically defined by the preamble to claim 1.

In gear mechanisms for hand power tools, sintered gear wheels with a spiral or straight gearing are used, for reasons of cost. Recourse to gear wheels that are cut, whose production costs are relatively high, is had only whenever stringent demands for running smoothness are made, in the case of high-quality appliances. Plastic gear wheels, which can be produced at a similar cost to sintered gear wheels, can transmit only low torques and are therefore used in hand power tools only in a few exceptional cases.

Pairs of gear wheels put together from sintered gear wheels have the disadvantage, dictated by their production, of major tolerances, which causes loud running noise and has an adverse effect on the service life.

### ADVANTAGES OF THE INVENTION

The gear mechanism of the invention, in particular for hand power tools, having the characteristics of claim 1 has the advantage that because of the damping elements incorporated between the damping elements, preferably of rubber or rubberlike material with a high damping factor, that are incorporated between the driving gear wheel and the driven shaft and act in the circumferential direction or tangential direction, tolerances and in particular pitch errors, profile deviation and errors of concentricity, existing in the paired gear wheels can not only be compensated for, markedly lessening the gear noise and vibration caused by the gear mechanism, but the very high startup forces acting on the gearing, which occur when the drive motor that turns the drive shaft upon being switched on because of the inertia of the drive and of the driven masses, and the load peaks that occur in operation at the gearing can all be reduced. Overall, this leads to highly smooth running in the case of sintered gear wheels, and regardless of the type of gear wheels (sintered or cut), because of the reduced mechanical load, the result is a long service life of the gear mechanism.

By the provisions recited in the further claims, advantageous refinements of and improvements to the gear mechanism defined by claim 1 are possible.

In a preferred embodiment of the invention, the driven gear wheel is seated rotatably on the driven shaft and has pockets, offset from one another in the circumferential direction, that are defined by radial side walls. The damping elements rest in the pockets with contact against the radial side walls and are retained on a slaving device that is joined to the driven shaft in a manner fixed against relative rotation, which slaving device is fixed axially nondisplaceably on the driven shaft.

In an advantageous embodiment of the invention, the slaving device has a ring seated on the driven shaft in force- and form-locking fashion and has a number of radial ribs, corresponding to the number of pockets in the driven gear wheel, of which each radial rib protrudes into one pocket. In each pocket, there are two damping elements, resting on each side of the radial rib, of which each damping element is braced on one side on the radial rib and on the other on a radial side wall of the pocket. The damping elements may be placed in the pockets or joined to the radial ribs, for instance spray-coated onto the radial ribs.

### DRAWING

The invention is described in further detail in the ensuing description in terms of an exemplary embodiment shown in the drawing. Shown are:

FIG. 1, an exploded of an angular gear for a hand power tool;

FIG. 2, a perspective view of the assembled gear mechanism in FIG. 1;

FIG. 3, a matrix for clear comparison of possible pocket and radial rib geometries in the gear mechanism of FIGS. 1 and 2.

### DESCRIPTION OF THE EXEMPLARY EMBODIMENT

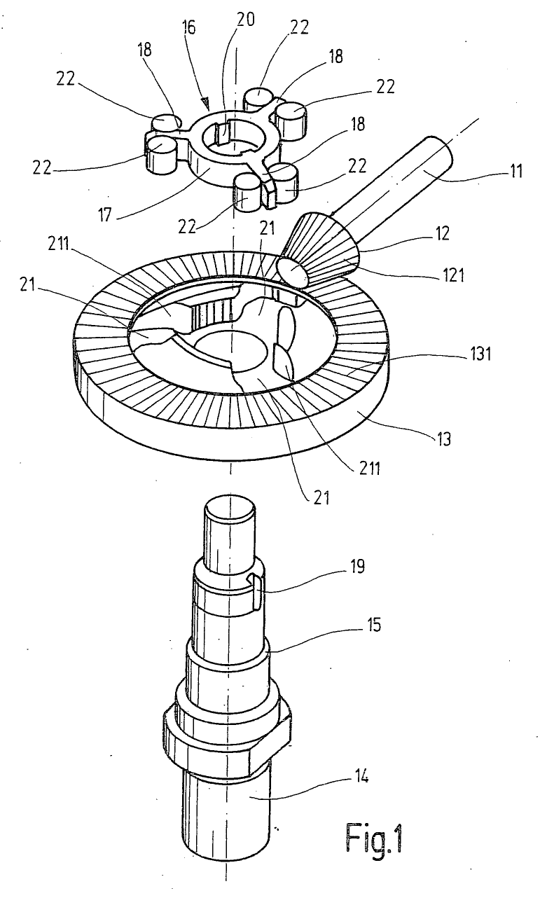

The angular gear, sketched in an exploded view in FIG. 1, for a hand power tool as an exemplary embodiment for a gear mechanism in general has a drive shaft 11, which can be driven by an electric motor; a driving gear wheel 12, seated in a manner fixed against relative rotation on the drive shaft 11 and embodied here as a conical pinion with pinion gearing 121; a driven gear wheel 13 meshing with the driving gear wheel 12, which driven gear wheel is embodied as a ring gear with spur gearing 131; and a driven shaft 14, driven by the driven gear wheel 13. The driven gear wheel 13 sits without play, rotatably and axially nondisplaceably, on the driven shaft 14; in the axial direction, it is braced on one side on an annular shoulder 15 (FIG. 1) embodied on the driven shaft 14 and on the other on a slaving device 16, which is pressed onto the driven shaft 14 and is additionally joined by force-locking to the driven shaft 14. The slaving device 16 has both a ring 17, surrounding the driven shaft 14, and a plurality of radial ribs 18, in this exemplary embodiment three of them, that are offset in the circumferential direction and are embodied integrally with the ring 17 or instead are in multiple parts. The driven shaft 14, in the region of the ring 17, has two diametrically located axial grooves 19, and the ring 17 has two diametrically located cams 20, protruding from the inner surface of the ring, which plunge in form-locking fashion into the axial grooves 19. In the exemplary embodiment, the radial ribs 18 are offset by equal circumferential angles and each protrude centrally into pockets 21 that are integrally formed in the driven gear wheel 13 at the same rotational angle spacing as the radial ribs 18. The pockets 21 are each defined in the circumferential direction by radially oriented side walls 211. Two damping elements 22 of spring-elastic material, such as rubber, are located in each pocket 21, and each damping element 22 rests on one side on a radial rib 18 and on the other on a side wall 211 of the pocket 21. The damping elements 22 are either inserted into the pockets 21 upon the assembly of the gear mechanism, or are solidly joined beforehand to the radial ribs 18.

When the electric motor is switched on, the torque is transmitted from the drive shaft 11 to the driven gear wheel 13 via the driving gear wheel 12. Since the driven gear wheel 13 is seated rotatably on the driven shaft 14, the driven gear wheel 13 can initially rotate by a few degrees, compressing the damping element 22 located behind it in the direction of rotation, and then, via the radial ribs 18, it can rotate the slaving device 16 and—since the slaving device 16 is seated on the driven shaft 14 in a manner fixed against relative rotation—it can drive the driven shaft 14. Thus by means of the damping elements 22, rotation is made to occurs in the driven gear wheel 13 even without rotation occurring at the driven shaft 14. As a result of this delay, the maximum acceleration that occurs is reduced, and the time until the full idling rpm of the driven shaft 14 is reached is prolonged. Thus the heavy load on the gearing between the driving gear wheel 12 and the driven gear wheel 13 upon startup is reduced.

In operation of the hand power tool, the striking of the teeth between the pinion gearing 121 and the spur gearing 131 is damped by the damping elements 22, causing a marked reduction in the gear rattling that is clearly perceptible in conventional hand power tools, particularly upon startup or shutdown of the hand power tool. The front damping elements 22, in terms of the direction of rotation, are particularly decisive for this; they damp the impacts that occur counter to the direction of rotation.

In work with the hand power tool, it sometimes happens that the tool briefly catches in the workpiece. In work with right angle grinders and cutting wheels, for instance, this often occurs. In this catching, which is equivalent to a brief blockage of the tool, extreme forces are exerted on the gearings 121, 131 between the driving gear wheel 12 and the driven gear wheel 13. These force peaks are effectively attenuated by the damping elements 22, leading to a reduction in the recoil moment that the user cannot fail to perceive, thus making tool use more comfortable for the user. Overall, the mechanical loads on the gear mechanism are reduced, which leads to longer service lives and perceptibly greater comfort, since gear vibrations, impacts and the like are transmitted to the tool housing only greatly attenuated.

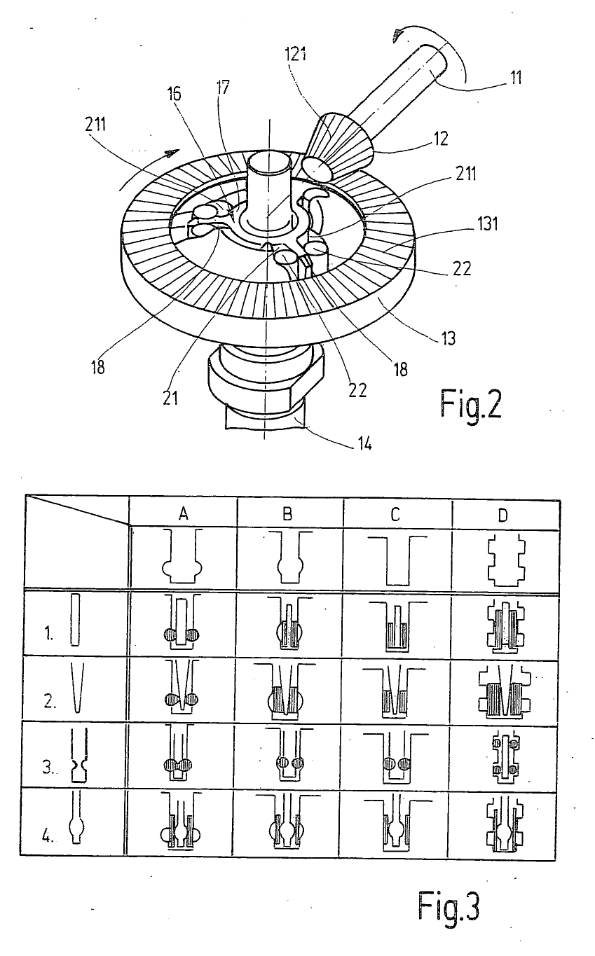

In the exemplary embodiment shown in FIGS. 1 and 2, the pockets 21 are embodied with a rectangular inside cross section, which is defined in the circumferential direction by two radial, flat side walls 211. The radial ribs 18 that protrude into the pockets 21 have a rectangular cross section. The damping elements 22 may have an arbitrary geometry. In the exemplary embodiment, they are embodied for instance as elastic roller-like bodies, which are oriented parallel to the axis of the driven shaft 14. It is understood that modified geometries of the pockets 21 and radial ribs 18 are possible, and the number of radial ribs 18 and correspondingly the number of pockets 21 may also be varied.

FIG. 3 shows a matrix that illustrates possible combinations of pocket geometries and radial rib geometries. Various internal profiles of the pockets 21 are plotted In the top line, while various profiles of the radial ribs 18 are plotted in the column on the left. All the pocket profiles A, B, C and D may be combined with the corresponding radial rib profiles in lines 1, 2, 3 and 4. The matrix is self-explanatory, and so only a few of its special features will be pointed out here:

In column C, the pocket 21, as in the exemplary embodiment of FIGS. 1 and 2, has flat side walls. In columns A, B and D, the side walls are provided with convexities, which can be embodied either in curved or angular form. Upon the deformation of the damping elements 22, these convexities accommodate a portion of the material of the damping elements 22, so that the spring properties of the damping elements 22 are improved. As shown in the left-hand column, the profiles of the radial ribs 18 may be embodied as rectangular, wedge-shaped, and rectangular with concavities (line 3) and convexities (line 4). In all the instances of combinations of the pocket profile and radial rib profile, the damping elements 22 are braced, as before, on the radial rib 18 and on the two side walls 211 of the pockets 21. In the combinations A/1, A/2, A/3, B/3, C/3, and D/3, the damping elements 22 are embodied as either spherical or roller-shaped; in the case of the roller shape they extend in the radial direction.

1. A gear mechanism, in particular for hand power tools, having a driving gear wheel (12), seated in a manner fixed against relative rotation on a drive shaft (11), and a driven gear wheel (13), meshing with the driving gear wheel and driving a driven shaft, characterized in that spring- elastic damping elements (22) are located between the driven gear wheel (13) and the driven shaft (14).

2. The gear mechanism of claim 1, characterized in that the driven gear wheel (13) is seated rotatably on the driven shaft (14) and has pockets (21), offset from one another in the circumferential direction, that are defined by radial side walls (211); and that the damping elements (22) rest in the pockets (22) with contact against the radial side walls (211) and are retained on a slaving device (16) that is joined to the driven shaft (14) in a manner fixed against relative rotation.

3. The gear mechanism of claim 2, characterized in that the slaving device (16) is fixed axially nondisplaceably on the driven shaft (14).

4. The gear mechanism of claim 3, characterized in that the driven gear wheel (13) is braced in the axial direction on the one side on an annular shoulder (15) embodied on the driven shaft (14) and on the other on the slaving device (16).

5. The gear mechanism of claim 2, characterized in that the slaving device (16) has a ring (17), seated on the driven shaft (14), and a number of radial ribs (18) corresponding to the number of pockets (21) in the driven gear wheel (13), of which ribs one protrudes into each pocket (21); and that two or more damping elements (22), resting on each side of the radial rib (18), are provided in each pocket (21), of which damping elements each one is braced on the radial rib (18) and on a radial side wall (211) of the pocket (21).

6. The gear mechanism of claim 5, characterized in that the ring (17) of the slaving device (16) is pressed onto the driven shaft (14).

7. The gear mechanism of claim 5 , characterized in that the ring (15) of the slaving device (16) is joined in force-locking fashion to the driven shaft (14).

8. The gear mechanism of claim 3, characterized in that the radial side walls (211) of the pockets (21) have indentations in the region of contact with the damping elements (22).

9. The gear mechanism of claim 3, characterized in that the radial ribs (18) of the slaving device (16), at least in their region protruding into the pockets (21), have a rectangular profile, with or without concavities or convexities, or a wedge-shaped profile.

10. The gear mechanism of claim 1, characterized by its embodiment as an angular gear, in which the driven gear wheel (13) is embodied as a ring gear with spur gearing (131), and the driving gear wheel (12) is embodied as a conical pinion with pinion gearing (121).
